(19) United States
(12) Patent Application Publication
(10) Pub. No.: US 2022/0188625 A1
(43) Pub. Date: Jun. 16, 2022

(54) METHOD AND COMPUTER IMPLEMENTED SYSTEM FOR GENERATING LAYOUT PLAN USING NEURAL NETWORK

(71) Applicant: Poyen Hsieh, Taipei City (TW)

(72) Inventor: Poyen Hsieh, Taipei City (TW)

(21) Appl. No.: 17/118,631

(22) Filed: Dec. 11, 2020

(51) Int. Cl. G06N 3/08; G06N 3/04; G06K 9/62; G06F 30/13

(52) U.S. Cl. CPC G06N 3/08; G06N 3/04; G06F 30/13; G06K 9/6282; G06K 9/6262

(57) ABSTRACT

A computer-implemented system for generating a layout plan includes a memory and a processor coupled to the memory. The processor is configured to obtain an object or a map, input the obtained object or the obtained map to a pre-trained deep neural network (DNN) model, and output the layout plan as an action suggestion based on an output result the pre-trained DNN model, where the output layout plan is an optimal layout plan based on the weight of the DNN model.

### BACKGROUND

### Technical Field

The disclosure generally relates to a method and a computer-implemented system, and more specifically, to a computer-implemented system capable of performing layout planning using a pre-trained neural network.

### Description of Related Art

In layout design, objects are placed in space for various reasons. For example, an object may be placed at a location near an entry of a room or in relation to other object(s) for the purpose of convenient access. Alternatively, objects may be placed at a particular location in the space for the purpose of safety regulation. Furthermore, different spaces would have different purposes, where the rules for placing an object may also change. For example, a layout for a kitchen, a living room, and a dining room would have different rules or preferences due to the purpose of the space. On top of that, different designers may have different opinions on how objects should be placed in a room. When designing a layout plan for a room, the designer or architect typically has to consider a number of factors in addition to the physical dimensions of the objects and room. Therefore, it has become a time-consuming process to design a layout plan due to the complexity of various factors to consider.

### SUMMARY

The disclosure provides a method and a computer-implemented system that automatically design a layout plan of a space by using a deep neural network (DNN) model that is trained by a set of predetermined rule and feedbacks. Due to the countless conditional factors in designing a layout plan, the embodiments train the deep neural network model using data acquired through a self-play mechanism that is enabled with evaluation metrics. Furthermore, a virtual design assistant is used to guide the designing of the layout plan in some embodiments. The decision of a design step may be incorporated into the training of the neural network, so as to output optimal layout plans.

In the disclosure, a computer-implemented system for generating a layout plan of a map is provided. The system includes a memory and a processor coupled to the memory. The processor is configured to obtain the map for generating the layout plan, input the map to a pre-trained deep neural network (DNN) model, and output an action suggestion based on an output result of the pre-trained DNN model.

In the disclosure, a method for generating a layout plan of a map is provided. The method includes at least the following steps: obtaining the map, inputting the map to a pre-trained deep neural network (DNN) model, and outputting an action suggestion based on an output result of the pre-trained DNN model.

In the disclosure, a non-transitory computer-readable recording medium storing a program is provided. When the program is loaded by a computer, the computer is configured to obtain the map for generating the layout plan, input the map to a pre-trained deep neural network (DNN) model, and output an action suggestion based on an output result of the pre-trained DNN model.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating the placement of an object in a map according to some embodiments of the disclosure.

FIG. 2 is a block diagram illustrating a workflow of a system for layout planning according to some embodiments of the disclosure.

FIG. 3 is a state diagram illustrating a tree search algorithm according to some embodiments of the disclosure.

FIG. 4 is a diagram illustrating a process of generating scores for the legal states according to some embodiments of the disclosure.

FIG. 5 is a block diagram illustrating a computer system having a display according to some embodiments of the disclosure.

FIG. 6 is a flow diagram illustrating a process flow of generating a layout plan through a DNN model according to some embodiments of the disclosure.

FIG. 7 is a flow diagram illustrating a process flow of generating a layout plan through a DNN model according to some embodiments of the disclosure.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The disclosure provides a method and a computer-implemented system that automatically design a layout plan of a space by using a deep neural network (DNN) model that is trained by a set of predetermined rule and feedbacks. Due to the countless conditional factors in designing a layout plan, the embodiments train and use the deep neural network model using data acquired through a self-play mechanism that is enabled with evaluation metrics. Furthermore, a virtual design assistant is used to guide the designing of the layout plan in some embodiments. The decision of the accepted design may be incorporated into the training of the neural network, so as to output optimal layout plans.

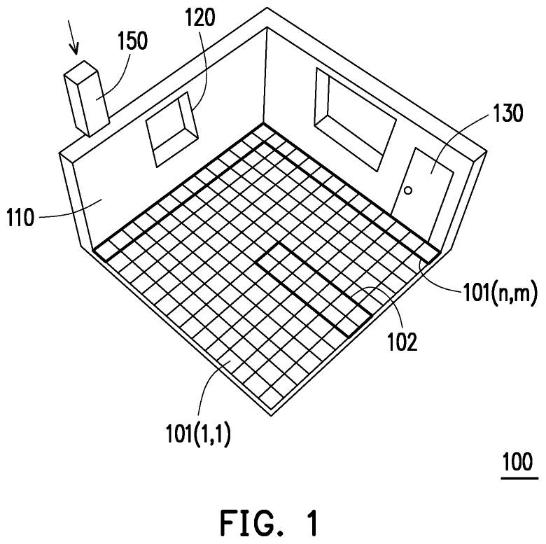

FIG. 1 is a diagram illustrating the placement of an object in a map according to one of the embodiments of the disclosure. In the embodiments, a kitchen layout design is used as an example, and it is not intended to limit the disclosure. In other embodiments, other maps such as living room, office, and any space that requires a layout design may be used. In FIG. 1, a map 100 is illustrated. The map 100 includes m by n cells 101(1, 1)-101(n, m), where an object may be placed in each of the cells. Each of the cells may include actionable information (attributes) that classifies the cells as a legal cell, a conditional cell, an illegal cell, an island cell, a peninsula cell, etc. Furthermore, each of the cells may also include environmental information that indicates the cell is next to a wall, a window, a door, an open area, etc. In the embodiments, the map 100 includes a wall 110, a window 120, and a door 130 as an example. The cell in the vicinity of the wall 110, the window 120 and the door 130 would carry the environmental information, and these cells may also be classified as the legal cell, the conditional cell, the island cell, the peninsula cell, or a combination thereof. For example, the cells that is in the vicinity of window 120 may be classified as the conditional cells, which indicates that the object being placed at those cells should not exceed a predetermined height.

In the embodiments, an object 150 to be placed onto the map 100 includes geometry information and placement information. The geometry information includes the physical size and physical shape of the object. The placement information may include the desired rule of the placement of the object. The desire rule may indicate that the object may be placed against a wall, on an island, or on a peninsula. The desire rule may also include a facing direction, clearance distance, etc.

When placing the object onto the map, various factors may be considered by a designer. Taking the kitchen layout environment as an example, some basic factors may include, but not limit to, an object can only be placed against a wall, on an island, or a peninsula, facing the direction of the object, an object such as pantry and fridge are not allowed to be placed in front of a window, an object should not be placed that gets in the way of another object's clearance zone, geographical location of an object, etc. It should be noted that this list of basic factors is for the purpose of explanation and should not be limiting. Additional factors may be considered when designing a kitchen layout. For example, a cooking workflow from a fridge to a sink to a stove based on their geometric locations, worktop area on each side of the stove, worktop area between a stove and a sink, the geometric relation of a dishwasher and a sink, etc. Moreover, due to safety concerns, the stove should not be placed next to a curtain or other flammable objects. In addition, there are other preferences, such as that the geometric location of the fridge should have easy access, the sink and the stove should not be located at countertop ends, etc. The design of a layout plan has become complicated and a time-consuming process due to these various factors. Conventionally, these rules are programmed into a rule-based system, which is utilized to place an object onto a map, where a rule-based statement may be used to describe the relationship between objects and the cells in the map. The disclosure introduces a self-play algorithm to explore all possible placements of an object in the map and a deep neural network to learn the outcomes of the self-play algorithm, as to produce an optimal layout plan or a sub-optimal layout plan.

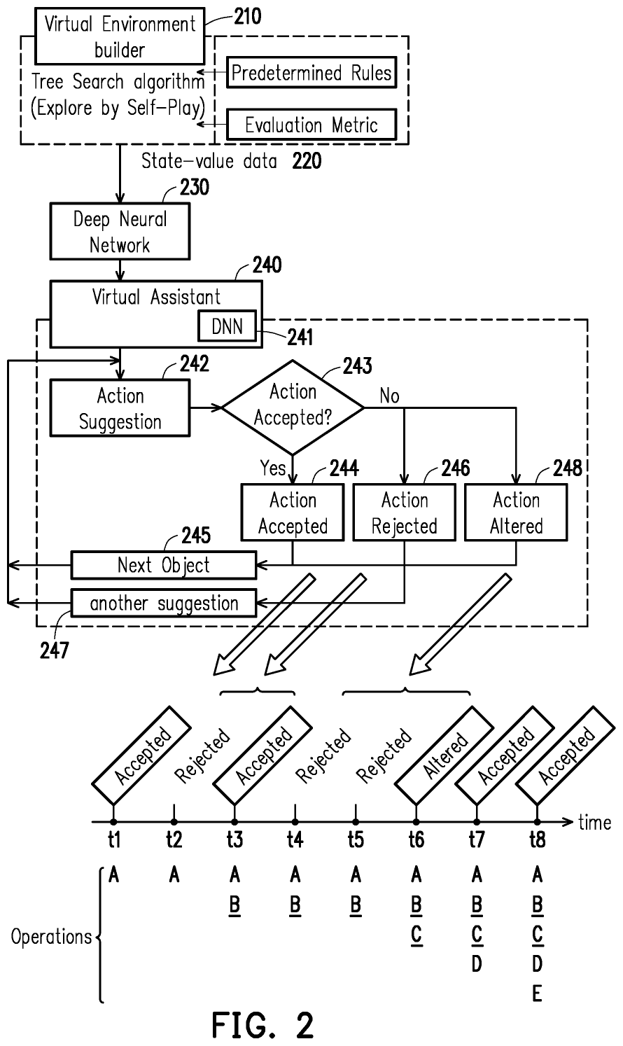

FIG. 2 is a block diagram illustrating a workflow of a system for layout planning according to some embodiments of the disclosure. In the embodiments, the workflow of the system may be classified into two stages. The first stage would be the creation of a virtual environment 210 by training the deep neural network, and the second stage would be an application of the virtual environment through a virtual assistant 240. The virtual environment 210 includes a tree search algorithm (agent), predetermined rules, and evaluation metrics, where the tree search agent explores possible arrangements of objects in the map and collect data to train the deep neural network 230. The trained deep neural network 230 then acts as the brain of the virtual assistant 240, who provides action suggestions 242 for placing object(s) on the map. The provided action suggestion may be accepted, rejected, or altered. When the action suggestion is rejected, another action suggestion may be requested. Alternatively, the action suggestion may be altered by a user operation or the virtual assistant 240. In one of the embodiments, a graphical user interface may be used to provide a step by step guide for generating a layout plan for space, which may be referred to as a conversational co-creativity workflow. The graphical interface may suggest a final layout plan as the action suggestion or placements of an object in a sequence.

As described above, designing the layout plan for space may be complicated due to various factors to consider. The map of each space may have its own actionable information and environmental information to consider, and each object may also have its own rule to follow with respect to the information of the map. In the embodiments, the virtual environment 210 uses a (self-play) tree search algorithm, constrained by the predetermined rules, using evaluation metrics, to explore all state values of the map. The state value is the state's best possible output score of the end states (e.g., layout plans) it may reach. For example, an object may be placed in any one of the cells illustrated in FIG. 1. Assuming that there are 5 objects to be placed, the total action space would be 5 times the total number of cells in the map (i.e., n×m). However, not all of the actions make design sense. For example, one would not place a fridge in the middle of the map or on top of an object that has already been placed, which may be classified as illegal actions. Therefore, the predetermined rules are implemented to rule out illegal actions that lead to illegal states (absurd and useless states). The fewer legal actions (e.g., placement of objects in the map that makes sense) would lead to a smaller pool of possible end states as layout plans (may also be referred to as solution spaces). After the tree search algorithm reaches an end state, the layout plan is evaluated and scored (i.e., evaluation metrics.) In some embodiments, the evaluation may be performed by designers, architects, or anyone who acts as a trainer. It should be noted that the weights and priorities of the metrics are subjective to the user and can be altered by various factors. For example, in the previous kitchen layout design, the sink placed in front of a window in a given map may be scored differently based on personal preferences. Someone who cooks a lot may not appreciate the extra steps every day, whereas someone who cooks occasionally may accept the tradeoff for a window view at the sink. Based on the preferences of a designer or user, the end state (layout plan) may be scored differently.

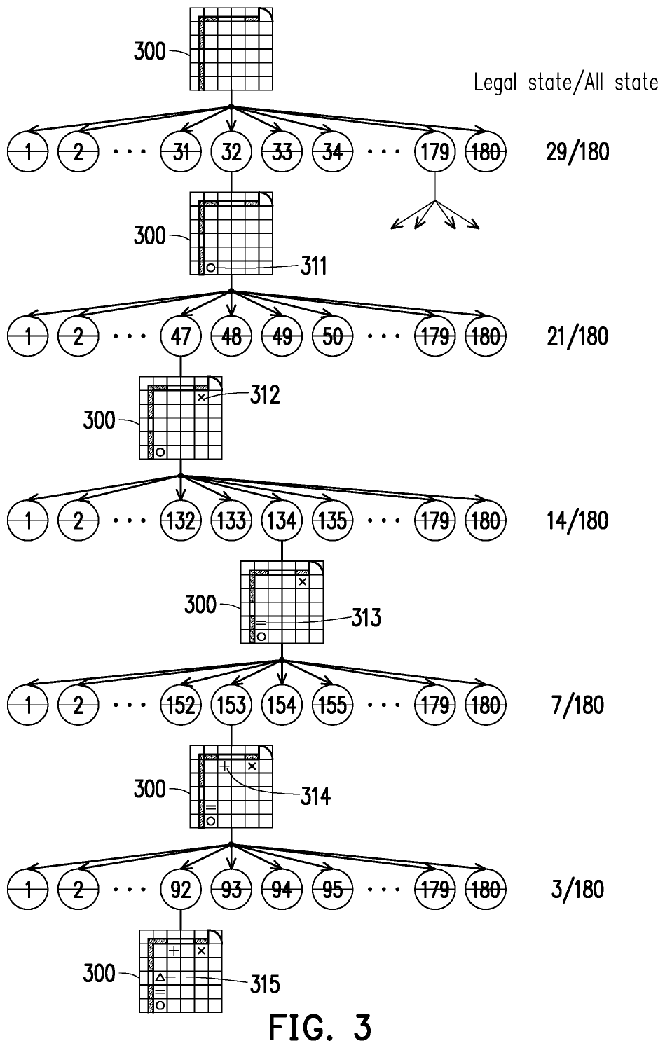

FIG. 3 is a state diagram illustrating the tree search algorithm according to some embodiments of the disclosure. In the embodiments, a map 300 is provided to produce a layout plan for placing 5 objects 311-314 (represented by “O”, “X”, “=”, “+”, and “Δ”) as an example. In the disclosure, the objects may be provided by the DNN due to the functionality or purpose of the map provided. For example, the map 300 may be a map of a kitchen. The DNN may automatically determine the objects to be filled in the map to be, for example, sinks, stove, counter, fridge, etc. Alternatively, the objects may be provided at the same time as the map. In other words, the objects to be placed are predetermined or pre-selected.

In the embodiment, the map 300 is divided into a 6 by 6 square matrix as an example. The placement of each of five objects may have 180 possible actions (i.e., 5×6×6.), which lead to 180 possible states Each object placement would be referred to as an action in a level (or a layer) of the tree search algorithm. With reference to FIG. 3, the tree search algorithm starts with the map 300 in the first level. Then, the tree search algorithm explores 180 possible actions (represented by arrows), which leads to 180 possible states (represented by circles) in a second level. Based on the predetermined rules for placing an object in a space, the tree search algorithm explores all possible combinations and defines each state to be legal or illegal in each level of the tree search algorithm. FIG. 3 shows a branch of the self-play tree search algorithm based on the predetermined rule as an example. It should be noted that a branch path of the 32^{nd} state for placing a first object 311 onto the map 300 (which is referred to as a second level below) is shown as an example branch of the tree search algorithm. In the embodiments, each of the other 28 legal states in the second level and other states in other levels may also have a branch similar to the branch illustrated in FIG. 3. For example, the 179^{th} state of the second level is also illustrated as a legal state, which may lead to other legal states in the lower levels of the tree search algorithm. It also should be noted that other maps having different shapes as compared to map 300 may also be included in the tree search algorithm, which may also result in the branch as illustrated in FIG. 3. Other maps may have different shapes such as L-shape, U-shape, any irregular shapes, rectangular shape (e.g., strip). Maps with different shape may be a matrix having different number of cells, which leads to a various number of possible states in each level of the tree search algorithm. The self-explore of the tree search algorithm on various maps and objects would create more states that lead to other layout plans.

With reference to FIG. 3, there are six levels of tree search. In the first level of an episode, the map 300, which may be filled with doors, windows, walls, floor, and legal cells, is provided. In a second level, a first object 311 (represented by “O”) is placed onto the map 300. Based on the predetermined rules, the placement of the first object 311 would result in 29 legal states (i.e., legal actions) out of 180 possible states, where the 32^{rd} states from the 29 legal states out of 180 states is illustrated as the exemplary branch. In other words, the tree search algorithm determines that there are 29 legal states out of all possible states based on the predetermined rules for placing the first object 311 in the map 300. It should be noted that the placement of the first object 311 includes the placements of all of the five objects to be placed in the first level. The first object refers to an object to be placed first, rather than a particular object such as a fridge. Each possible action (i.e., placement of an object) would place one of the five objects onto the map 300, which leads to one state. In view of the map 300, each object may be placed at 36 (6×6) different cells in the map 300. The placement of all five objects as the first object 311 in the first level would result in 180 different states in the first level of the tree search algorithm. The same definition also applies to the description of placing a second object 312, a third object 313, a fourth object 314, and a fifth object 315 below.

In a third level of the tree search algorithm, the placement of the second object 312 (represented by “X”) in the map 300 in view of the first object 311 (e.g., the 32nd action in the second level) may have 21 legal states out of 180 states based on the predetermined rules for placing the second object onto the map 300. The 47^{th} state in the third level of the tree search algorithm is used for illustration. In a fourth level of the tree search algorithm, the placement of the third object 313 (represented by “=”) in view of the 47^{th} legal state in the third level may obtain 14 legal states out of 180 states in the fourth level. The 134^{th} state of the fourth level is used when placing the fourth object 314 in the map 300 in a fifth level of the tree search algorithm as an example. As a result, there are 7 legal states out of 180 states in the fifth level based on the predetermined rules for placing the fourth object 314 onto the map 300. The 92^{rd} action is used to illustrate a sixth level of the tree search algorithm, where the fifth object 315 (represented by a “A”) is placed onto the map 300 with the first, second, third, and fourth objects 311, 312, 313, 314. In the embodiment, the sixth level of the tree search algorithm includes 3 legal states out of 180 states. Since the fifth object 315 is the last object to be placed, these legal states in the sixth level would be considered as 3 possible end states of the tree search algorithm based on predetermined rules. The end states may be referred to as layout plans, where each layout plan includes five placed objects in the map 300. In this branch of the tree search algorithm, each of the 3 legal states presents a possible layout plan out of 179,046 possibilities (i.e., 29×21×14×7×3) for placing 5 different objects in the map 300. Other legal states result from other branches of the tree search algorithm would also produce other plan layouts.

It should be noted that the branch illustrated in FIG. 3 is simplified for the purpose of brevity. In full context, each level may result in multiple branches. For example, in the second level, the tree would produce 28 other branches based on the other 28 legal actions and result in more layout plans. Then, each of the other 28 branches may grow to have 21 or any other number of sub-branches in the third level and so on. It should be noted that the legal states in each level of the tree search algorithm are based on the predetermined rules. The predetermined rules may include the environmental information of the test map, the actionable information of the test map, the geometry information of an object, the preferences of object placement, etc. In the kitchen layout example, the predetermined rules may include: 1) appliances can only be placed against a wall, on an island, or a peninsula, 2) facing direction of appliances, 3) tall appliances are not allowed to be placed in front of a window, 4) clearance zone of appliances (e.g., door). The list of the predetermined rule is not intended to be limited thereto, and other rules may be included.

Next, the evaluation metrics are enabled to score the layout plans explored by the tree search algorithm. In the embodiments, the layout plans may be evaluated by a designer or any user, where scores may be assigned to some (e.g., 3, 10, 15, or any number of layout plans) or each of the layout plans. As described above, the parameters and priorities are subjective to personal preference. The preference may involve the location of an object having a particular function in the map. For example, a person who cooks occasionally may enjoy a window view when a sink is placed in the window, while a person who cooks a lot may not appreciate the extra steps. In another example, such as a refrigerator, a person may not appreciate the extra steps from a living room to the refrigerator even though the refrigerator is close to the sink or a counter. The evaluation metric may involve various factors such as a workflow in the room, an arrangement of the objects for a design style, and so on.

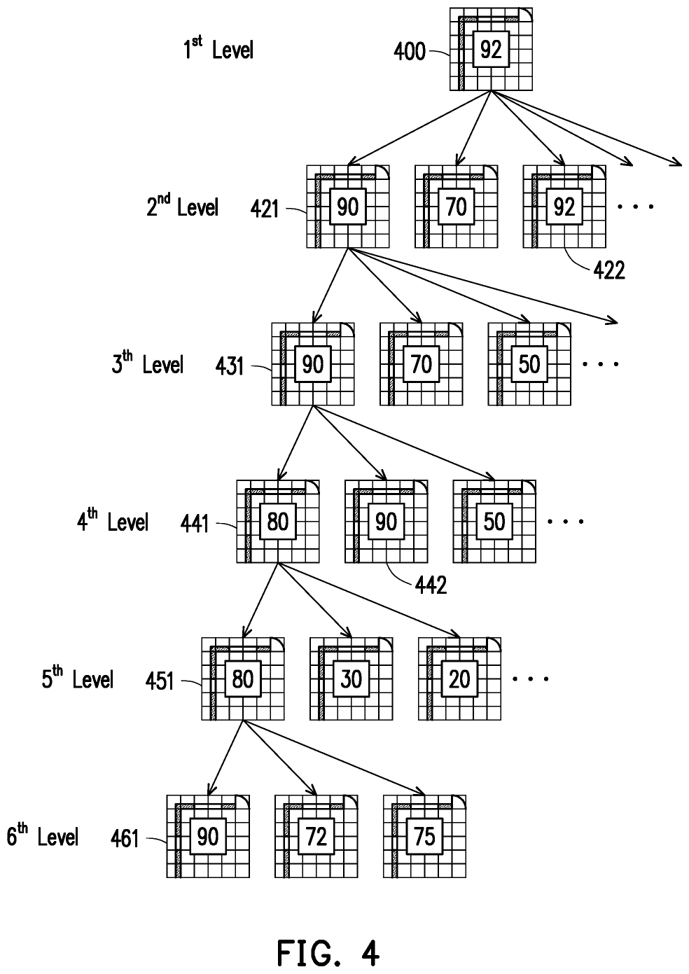

In the embodiments, the score of the final layout plan (end state) may be used to assign a score to the legal states in each level of the tree search algorithm. The legal states would be assigned with the highest score of the corresponding layout plan to which the legal states may lead. FIG. 4 is a diagram illustrating a process of generating scores for the legal states according to one of the embodiments of the disclosure. In the embodiments, the legal states of different levels of the tree search algorithm and the corresponding scores are shown. It should be noted that only three states are shown for each level for the purpose of illustration only. More states may be included. In the embodiments, the legal states in the sixth level are the layout plans (i.e., end state), and these layout plans are scored with the evaluation metric as described above. The score of the layout plans may be used to score the legal states in a backward manner, i.e., the states of previous levels in the branch may be scored based on the score of the layout plans. For example, the layout plan 461 has a score of 80, which is the highest among other layout plans that have scores of 72 and 75. In such a case, the score (80) of the layout plan 461 would be used to score the legal state 451 in the fifth level since 80 is the highest score among the states of the sixth level. From another point of view, the legal state 451 may lead to a layout plan that has a score of 80. Similarly, the legal state 441 may be scored with the score of the legal state 451 (which is 80) since 80 is the highest score among all of the legal states in the fifth level. In the third level, the legal states 431 is scored with the score of the legal state 442 (i.e., a score of 90), since legal state 442 has the highest score among all of the legal states (scores of 80 and 50) in the fourth level. In other words, the branch of legal state 442 may lead to a layout plan in the end state that has a score of 90, which is higher than the score of the layout plan 461. In the second level, the legal state 421 is scored with the score of the legal state 431. In the first level, the map 400 would be assigned with the score of the legal state 422 rather than the legal state 421, since the legal state 422 has a score higher than the score of the legal state 421. That is, the legal state 422 may lead to a layout plan at the end of the tree search algorithm that has a score of 92, which is higher than the score of the legal state 421.

As a result, the tree search algorithm outputs the state-value data 220 that includes end states (i.e., layout plans), legal states, and the corresponding scores to train the deep neural network 230. These scores are being used by the deep neural network 230 to generate suggestions in the virtual assistant in assisting a user in designing a layout plan.

The deep neural network 230 uses the state-value data 220 from the tree search algorithm to establish the nodes and layers between the input and output of the network from scratch and re-trained whenever rules, metrics, or objects change to reflect the intrinsic state values of the new environment. The deep neural network 230 is essentially trained to find the correct mathematical manipulation to better predict the state values of any given state (or possible legal actions), even from an unseen map, by learning from available state-value data 220 output by the tree search algorithm. The deep neural network 230 moves through the layers and calculates the probability of each output. The embodiment may be implemented with deep learning architectures with reinforcement learning algorithms (e.g., Q-learning, actor-critic), which may be referred to as deep reinforcement learning (DRL). However, the disclosure is not intended to limit the type of neural network being applied, and various neural network models may be applied to implement the disclosure.

In the example above, the deep neural network is trained by using a map and 5 objects to be placed in the tree search algorithm. It should be noted that multiple maps and other numbers of objects to be placed may be used as inputs for the tree search algorithm for building the virtual environment 210 and training the deep neural network 230. In some embodiments, the tree search algorithm only explores a portion of the layout plans that are then evaluated and scored with state-values data 220. Such is still sufficient to train the deep neural network 230. As long as the state-values of the explored states are of good quality and are close enough to their true value, the DNN can generalize to the unexplored state.

In some embodiments, the trained deep neural network 230 predicts the values of all possible next states (resulting from legal states) and may be configured to investigate only the best three legal states (out of 29 legal states) in the first level and the best two legal states (out of 21 legal states) for the levels subsequent to the first level. In this way, the time for processing inputs may be reduced.

Referring to FIG. 2, the deep neural network 230 generates an DNN model 241, which becomes part of the virtual assistant 240. From the aspect of the virtual assistant 240, a map and/or an object to be placed (e.g., a chair, a fridge, etc.) may be input to the DNN model 241. Based on the trained DNN model 241, the virtual assistant 240 may suggest an optimal action (i.e., action suggestion 242) based on predicted values of the possible next legal state in view of the input(s) to the DNN model 241. For example, the optimal action may be presented on display as the action suggestion. Once an action is suggested, the process goes to a determination step 243 for determining whether the suggested action is accepted, rejected, or altered. The determination may be performed according to an input signal received through a user interface where input may be asserted via any human-machine interface (HMI) such as a keyboard, mouse, touch panel, voice recognition, an image of the face of the user, etc. For example, a graphical interface may present the layout plan corresponding to a possible end state having the highest score (determined by the DNN model) with options such as “accept”, “reject”, and “alter”. In other embodiments, the graphical interface may present the layout plan along with a statement of whether the suggestion is accepted or rejected. There are various ways to present the action suggestion and its options to a user for obtaining a feedback. The disclosure is not intended to limit the embodiments to the description above.

The action suggestion may be accepted (step 244), rejected (step 246), or altered (step 248. In a case where the action suggestion is accepted in step 244, the virtual assistant advances step 245 to ask for an action suggestion for the next object and goes back to the beginning of step 242, or the virtual assistant ends the process when no other suggestion is available. In a case where the action suggestion is rejected (step 246), the process goes to step 247, asking for another suggestion on the placement of the object(s) in the map. In the embodiment, the virtual assistant provides a second-best action as another action suggestion for placing the same object(s). In a case where the action suggestion is intervened, an alternation option (step 248) may be selected. The presented layout plan or state may be modified. For example, one or more object(s) in the presented state or layout plan may be modified, such as deletion or addition of other object(s), reposition any object(s) in the map, etc. Then, the process goes to step 245 to ask for an action suggestion for placing the next object, or the process ends when there is no more object to be placed.

In some embodiments, the alternation of the action suggestion may be transmitted to the deep neural network 230 or the virtual environment 210 to update the evaluation metric so that the alternation may be considered in the future. Such a step may be referred to as re-training the deep neural network based on the alternation of the action suggestion made by the virtual assistant or user.

The action suggestion of the process above may be a step by step guideline for placing each and every object or a final layout plan having one or more object(s) to be placed. In the embodiments of the step by step guideline, a map, one or more object(s), or a combination thereof may be provided to the virtual assistant as input to the DNN model. The virtual assistant may present an action suggestion for placing each and every object(s) onto the provided map. For example, FIG. 2 illustrates the placement of 5 different objects onto a map. Each placement of an object onto the map may be referred to as an operation. In the embodiments, there are five operations (operations A, B, C, D, and E) for placing 5 objects onto the map at different times (i.e., t1, t2, t3, t4, t5, t6, t7, t8). The placement of the first object may be denoted as operation A, the placement of the second object may be denoted as operation B, and so on for placement of third, fourth, and fifth objects. In time t1, the virtual assistant 240 may first suggest placing the first object that has the highest score among other states based on the DNN model in step 241. Then, the virtual assist 240 determines whether the suggestion is accepted in step 243. The suggestion of operation A is accepted, the process would go to step 245 and back to the beginning for making an action suggestion (step 242) for the next object to be placed. In this case, it would be the placement of the second object, that is, operation B. In the embodiment, it is illustrated that the second operation is rejected (step 246). The process goes to step 247 to ask for another suggestion from the virtual assistant. At time t3, the operation B for placing the second object is accepted. Next, operation C would take 3 cycles, i.e., time t4, t5, t6, to place the third object. The first two action suggestions made by the virtual assistant are rejected at times t4 and t5. Then, alternation of action suggestion is made at time t6. The alteration may include the position and the content of the third object (i.e., changing from placing a stove to a countertop.) After the alternation, the process goes back to the beginning of the process (step 242) to continue with the action suggestions related to the fourth and fifth objects or until all objects are placed. In the embodiments, the operations B and C are illustrated as operations that the action suggestions are either rejected or altered. These operations are denoted with an underline (“B”, “C”) for the purpose of illustration, which indicates that the action suggestions on those operations were intervened by other inputs or not an action that would lead to the optimal layout plan.

In the embodiment of the final layout plan, the virtual assistant 240 may obtain a map solely as an input. In other embodiments, one or more object(s) may be provided with or without a map. Then, the DNN model 241 may automatically fill in one or more object(s) based on the functionality or purpose of the map. In other words, the suggested final layout plan may be referred to as a layout plan that the DNN model 241 considers as an end state having the highest score for the provided map. As illustrated in FIG. 2, The suggested final layout plan may be accepted, rejected, or altered. In some embodiments, the alternation of the suggested final layout plan may require selecting at least one portion of the suggested final layout plan to modify. The portion may be one or more object(s) on the final layout plan, the provided map, the addition of object(s), removal of object(s), etc. If the suggested final layout plan is rejected, the virtual assistant may provide another layout plan that is next in line in view of the score as a next action suggestion until the action suggestion is accepted or altered.

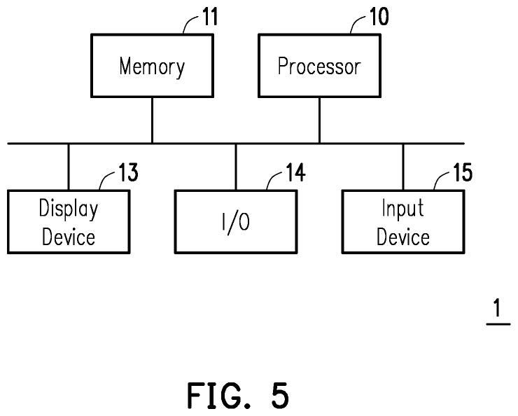

FIG. 5 is a block diagram illustrating a computer system 1 having a display device 13 according to some embodiments of the disclosure. The computer includes a processor 10, memory 11, an I/O interface 14, an input device 15, and the display device 13, which are interconnected by a system bus 12. In one of the embodiments, the processor 10 may include a multifunction processor and/or an application-specific processor. Examples of processors include the PowerPC™ family of processors by IBM and the x86 family of processors by Intel, such as the Xeon™ family of processors and the Intel X5650 processor. The memory 11 may include a non-transitory storage medium such as read-only memory (ROM), flash memory, RAM, and a large capacity permanent storage device such as a hard disk drive. The I/O interface enables input from other computers via, for example, Firewire, Ethernet, or USB. The input device may include a keyboard, mouse and/or touch inputs from any touch-sensitive panel.

The virtual environment 210 and virtual assistant 240 as described above may be implemented by the processor 10. In the embodiments, the computer 1 executes computer-readable instructions stored in the memory 11 using the processor 10 to implement the computer-implemented system described above. In one of the embodiments, the display device 13 may be integrated into the computer 1, as illustrated in the embodiment of FIG. 5 (e.g., a laptop or tablet computer). Alternatively, the display device 13 can be an external display device that communicates with the computer over a graphical input/output interface, such as a monitor attached by an HDMI cable to a desktop computer or a network server (not shown).

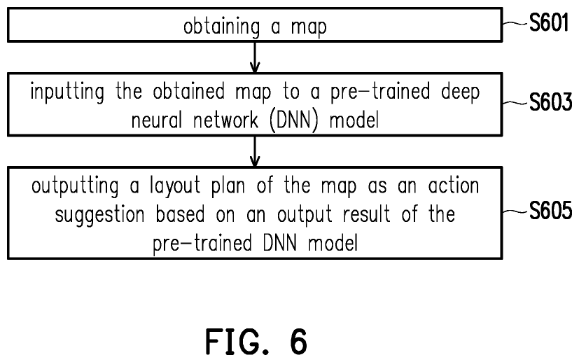

FIG. 6 is a flow diagram illustrating a process flow of generating a layout plan through a DNN model according to some embodiments of the disclosure. In step S601, a map is obtained as an input of a DNN model. In step S603, the obtained map is input to a pre-trained deep neural network (DNN) model. In step S605, the layout plan is output as an action suggestion based on an output result of the pre-trained DNN model. It should be noted that, with a map being input, the DNN model may automatically fill in various objects related to the map (based on the purpose of the map.) Thus, the layout plan output in step S605 would include various objects being placed onto the map.

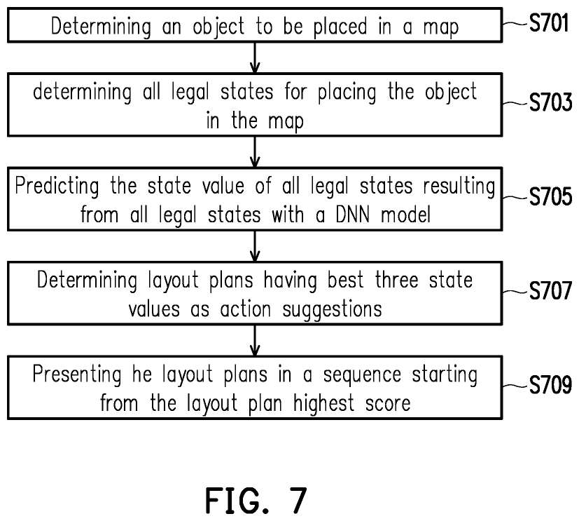

FIG. 7 is a flow diagram illustrating a process flow of generating a layout plan through a DNN model according to some embodiments of the disclosure. In step S701, object(s) to be placed in a map is determined. In step S703, all legal states of the object(s) are determined, where the legal states object(s) refers to the placement of the object(s) at a location of map that satisfies the predetermined rules. In step S705, state values of all legal states of the object(s) are predicted by the DNN model. In step S707, layout plans having the best three state values are determined as action suggestions. In step S709, the layout plans are presented in a sequence starting from the layout plan's highest score until the action suggestion is accepted.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-implemented system for generating a layout plan of a map, comprising:
a memory;
a processor, coupled to the memory and configured to:
obtain the map for generating the layout plan;
input the map to a pre-trained deep neural network (DNN) model; and
output an action suggestion based on an output result of the pre-trained DNN model.

2. The computer-implemented system of claim 1, wherein the processor displays an optimal action having a plurality of objects being placed in the map as the action suggestion on a display, wherein the optimal action has a highest score in the DNN model which is trained by using tree search algorithm with predetermined rule and enabled with evaluation metrics.

3. The computer-implemented system of claim 1, wherein the processor displays a placement of an object in the map as the action suggestion.

4. The computer-implemented system of claim 1, wherein the action suggestion includes a plurality of action suggestions for placing of a plurality of objects in the map.

5. The computer-implemented system of claim 1, wherein when the action suggestion is rejected, the processor is further configured to output another action suggestion which leads to another layout plan having a second highest score based on the DNN model.

6. The computer-implemented system of claim 1, wherein when the action suggestion is altered by other inputs, the processor is further configured to accept the altered action suggestion, and the altered action suggestion is used to re-train the DNN model.

7. The computer-implemented system of claim 1, wherein the pre-train DNN model comprises a plurality of model parameters trained by the map and a plurality of objects.

8. The computer-implemented system of claim 1, wherein the processor is further configured to train the pre-trained DNN model by using a tree search algorithm that explores all combinations of a plurality of object and a plurality of map under the predetermined rule, wherein each of the combination is scored by using evaluation metrics.

9. The computer-implemented system of claim 8, wherein the predetermined rule defines whether an object in a cell of the map is legal or illegal.

10. The computer-implemented system of claim 8, wherein the tree search algorithm includes a plurality of end states and a plurality of legal states that leads to end states, and only a portion or all of the end states are scored by using the evaluation metric, and each of the legal states includes a state scored by using the score of the end states.

11. The computer-implemented system of claim 1, wherein the processor is further configured to obtain an object as another input to the DNN model.

12. A method for generating a layout plan of a map, comprising:
obtaining the map;
inputting the map to a pre-trained deep neural network (DNN) model; and
outputting an action suggestion based on an output result of the pre-trained DNN model.

13. The method of claim 12, further comprising:
displaying an optimal action as the action suggestion on a display, wherein the optimal action has a highest score in the DNN model which is trained by using tree search algorithm with predetermined rule and enabled with evaluation metrics.

14. The method of claim 12, further comprising:
displaying a placement of an object in the map as the action suggestion.

15. The method of claim 12, further comprising:
when the action suggestion is rejected, outputting another action suggestion which leads to another layout plan having a second highest score based on the DNN model.

16. The method of claim 12, further comprising:
when the action suggestion is altered by other inputs, accepting the altered action suggestion, and transmitting the altered action suggestion to the DNN model to re-train the DNN.

17. The method of claim 12, wherein the pre-trained DNN model is trained by using a tree search algorithm that explores all combinations of a plurality of object and a plurality of map under the predetermined rule, wherein each of the combination are scored by using evaluation metrics.

18. The method of claim 17, wherein the predetermined rule defines whether an object in a cell of the map is legal or illegal.

19. The method of claim 17, wherein the tree search algorithm includes a plurality of end states and a plurality of legal states that leads to end states, and only a portion or all of the end states are scored by using the evaluation metric, and each of the legal states includes a state scored by using the score of the end states.

20. A non-transitory computer-readable recoding medium, storing a program, when loaded by a computer, causing the computer to:
obtain the map for generating the layout plan;
input the map to a pre-trained deep neural network (DNN) model; and
output an action suggestion based on an output result of the pre-trained DNN model.
